(19) United States
(12) Patent Application Publication
(10) Pub. No.: US 2002/0036386 A1
(43) Pub. Date: Mar. 28, 2002

(54) Binding

(76) Inventors: Stephen Murphy, Victoria (AU); David Scallion, Victoria (AU)

Correspondence Address: HARNESS, DICKEY & PIERCE, P.L.C., 5445 CORPORATE DRIVE, SUITE 400, TROY, MI, 48098, US

(21) Appl. No.: 09/941,178

(22) Filed: Aug. 27, 2001

Related U.S. Application Data
(63) Continuation-in-part of application No. 09/509,617, filed on Mar. 28, 2000, now Pat. No. 6,279,924.

(30) Foreign Application Priority Data
Sep. 30, 1997 (AU) PO9546/97

(51) Int. Cl. A63C 9/10; B62B 13/00

(52) U.S. Cl. 280/14.23; 280/623

(57) ABSTRACT

A binding (301) for releasably holding a boot (308), including a latch (330), arranged to pivot between an open position and an engaged position for securing the boot relative to the binding, and a lock mechanism (340) to provide incremental locking of the latch, as the latch pivots toward the engaged position, in order to restrict movement of the latch back toward the open position. The incremental locking allows for ease of entry into the binding and minimal force to manually release the boot. The binding also has an automatic release mechanism (360) to allow the binding to reset in an open position when the binding releases the boot.

### FIELD OF THE INVENTION

This invention relates to a binding particularly, but not exclusively, for a ski, snowboard or the like.

### BACKGROUND OF THE INVENTION

It is known to provide a snowboard with a binding arrangement to allow release of a ski-boot from the board when stress on the boot relative to the board exceeds a threshold level. International Patent Application No. PCT/FR96/01647 (WO 97/16226). for example, discloses such a binding arrangement which comprises front and rear bindings which are further interconnected to allow for automatic release of both boots in the event one of the boots is released due to overthreshold stress.

To secure each of the ski boots relative to the board each binding may be provided with an overcenter lock mechanism (as shown more specifically in, for example, U.S. Pat. No. 5,957,480) to securely grip the respective boot. In order to ensure the boot does not unintentionally dislodge from the binding, the over-center arrangement is configured such that a reasonably substantial entry force is required to engage the mechanism and a proportional, yet substantial, leverage force is required to manually release the lock mechanism.

### OBJECT OF THE INVENTION

It is an object of the invention to provide a binding for use with a ski, snowboard or the like, which is easier to engage and/or release.

### SUMMARY OF THE INVENTION

In accordance with the invention, there is provided a binding for releasably holding a boot, including:

a latch arranged to pivot between an open position and an engaged position for sccuring the boot relative to the binding;

a lock mechanism to provide incremental locking of the latch, as the latch pivots toward the engaged position, in order to restrict movement of the latch back toward the open position.

In another aspect, there is provided a binding for releasably holding a boot, including:

a latch arranged to pivot between an open position and an engaged position for securing the boot relative to the binding;

a lock element coupled to the latch; and

a lock mechanism for engaging the element to restrict rotation of the latch to the open position, wherein the lock mechanism is arranged to be displaced relative to the lock element to disengage the element and allow rotation of the latch to the open position.

In yet another aspect, there is provided a binding for releasably holding a boot, including:

a latch arranged to pivot between an open position and an engaged position for securing the boot relative to the binding;

a lock element coupled to the latch; and

a lock mechanism for engaging the element to restrict rotation of the latch to the open position, wherein the lock mechanism and element are arranged such that displacement of the mechanism relative to the element to disengage the element and allow rotation of the latch to the open position is effected by application of a release force of a predetermined magnitude, independent of an entry force required to pivot the latch into the engaged position.

In a further aspect, there is provided a binding for releasably holding a boot, including:

a latch arranged to pivot between an open and an engaged position for securing the boot relative to the binding;

a lock mechanism for restricting rotation of the latch to the open position; and

a release mechanism, responsive to absence of the boot from the binding, to disengage the lock mechanism to allow the latch to be reset to an open position for receipt of the boot.

### BRIEF DESCRIPTION OF THE DRAWINGS

The invention is described in greater detail hereinafter, by way of example only, with reference to a preferred embodiment thereof illustrated in the accompanying drawings, wherein:

FIG. 1 is an elevated rear isometric view of a snowboard fitted with a binding system, having binding plates mounted thereon;

FIG. 2 is an elevated side isometric view of the snowboard of FIG. 1;

FIG. 3 is an elevated isometric view of a front snowboard binding;

FIGS. 4, 5 and 6 are various views of the binding plate;

FIGS. 7 and 8 are plan and cross-sectional views of a binding base plate;

FIGS. 9 and 10 are side cross-sectional views of a section of a release mechanism of the binding;

FIGS. 11 and 12 are side partial cross-sectional views of the release mechanism illustrating manual release and automatic release mechanisms;

FIG. 13 is a diagrammatic perspective view of a snow ski and binding;

FIG. 14 is a diagrammatic cross-section of a heel assembly of the binding of FIG. 1, shown in an open position; and

FIG. 15 is a view similar to FIG. 14, showing the binding in an engaged position.

### DETAILED DESCRIPTION OF A PREFERRED EMBODIMENT

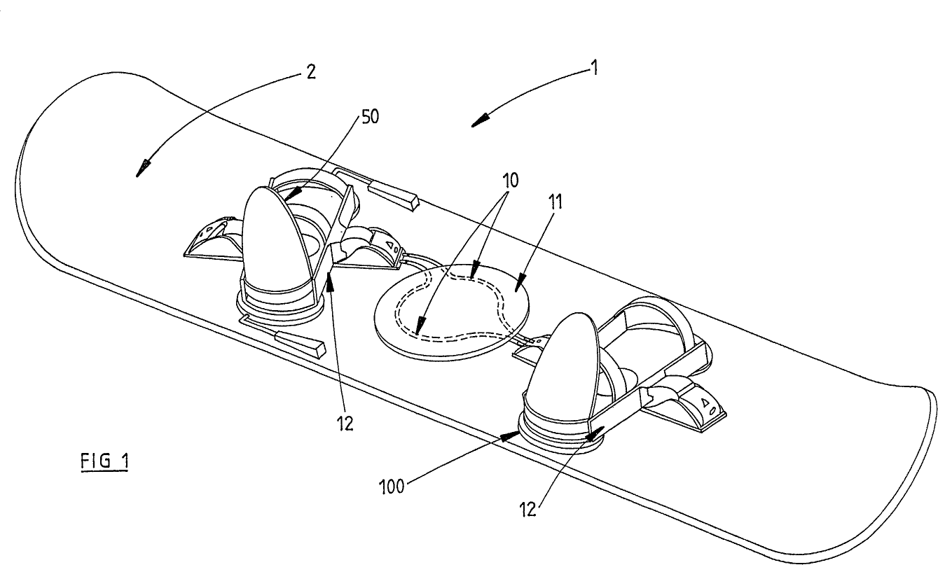

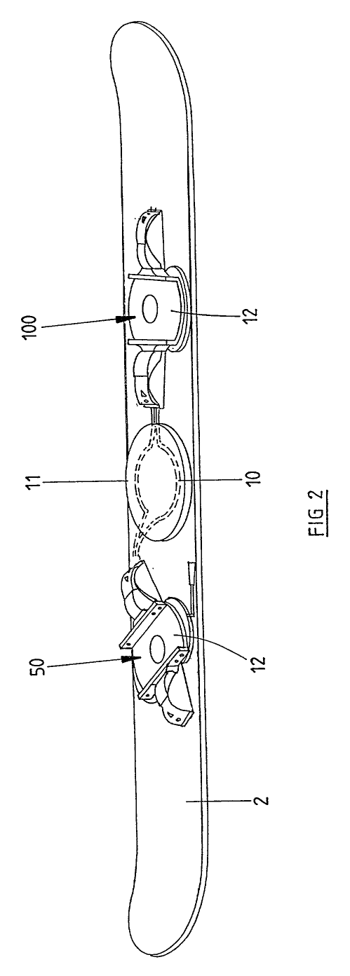

A binding system 1 is illustrated in FIGS. 1 and 2, fitted to a snowboard 2. The snowboard 2 itself is of conventional form, comprising a generally flat, elongate board structure with tapered or rounded and upturned ends. The bottom surface of the board 2 (not shown in the drawings) is constructed to contact and slide over snow and ice, whilst the top surface of the board is constructed to allow bindings to be fitted thereto to enable the user to secure his or her boots to the board. The side edges of the board are substantially parallel, and the board itself is generally symmetrical with respect to both the sideways and end-to-end axes. Thus, the “front” and “back” of the board is primarily determined by the mounting of the bindings, rather than the actual shape of the board itself, although more directionally oriented board constructions are of course possible. The board 2 is of the order of 1.5 meters long and 30 centimeters wide, although it will be appreciated that a significant range of different sized boards may be available depending upon the size of the user, the conditions, the specific use, anal personal preference, amongst other things.

The binding system 1 comprises a front binding 50 and a rear binding 100 which are both, in use, mounted on the upper surface of the board 2 as shown in the Figures. The front binding 50 is mounted toward the “front” of the board 2, and the rear binding 100 is of course mounted toward the “rear” end of the board. The front and rear bindings are coupled together by way of a flexible cable coupling 10. Where the cabling extends between the front and rear bindings it may pass under or through a central pad 11 mounted on the surface of the snowboard between the two bindings, so as to minimize the possibility of entanglement of the cables. In the construction shown in FIGS. 1 and 2, the front binding 50 is arranged to secure the left foot of the rider, and the rear binding 100 is arranged to secure the right foot, so that the rider, in use, faces substantially toward the right-hand side of the snowboard 2 as illustrated when viewed from above. Both the front and rear bindings are mounted to the board so that the rider's boots, when secured to the respective bindings, extend transversely of the length of the board 2. The rear binding is shown positioned so that the rider's right foot extends, in use, generally at right angles to the board's longitudinal axis. The front binding, is positioned so that the rider's left foot, in use, points somewhat toward the front of the board. The orientation of the bindings with respect to the axis of the board is, however, adjustable for each of the front and rear bindings individually, which is explained in greater detail hereinbelow.

Both of the front and rear bindings 50, 100 are shown in FIGS. 1 and 2 with respective binding plates 12 mounted therein. Each binding plate 12 is operatively affixed to a respective boot (not shown) which is in use worn by the rider, and the binding plates shown in FIG. 1 includes straps and the like necessary to affix the binding plate to the boot. As will be described in detail hereinbelow, it is the binding plate which is operatively secured to the binding and which is releasable from the binding in the event of abnormal forces being applied. Thus, the binding plate 12 is itself affixed securely to the rider's boot so that a coupling between the binding and binding plate can secure the boot, and thus the rider, with respect to the snowboard 2. The form of the binding plate utilized in the preferred embodiment of the present invention is relatively simple, which allows significant versatility in that the binding plate can attached to a conventional soft structure snowboard boot, or the operative portions of the binding plate can be incorporated into a snowboard boot specifically constructed for the binding of the present invention. For example, the binding plate 12 illustrated can be attached to a conventional snowboard boot by way of a conventional snowboard binding of the type described briefly hereinabove. The binding plate may be affixed to the bottom of the conventional strap-secured binding with screws, bolts or the like in the same way the binding would ordinarily be attached to the snowboard itself.

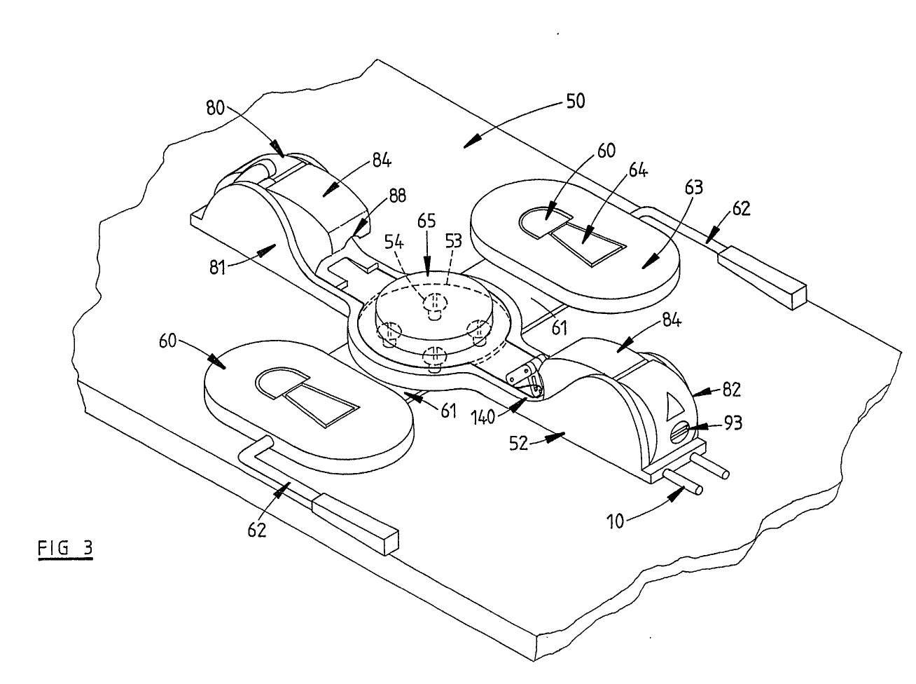

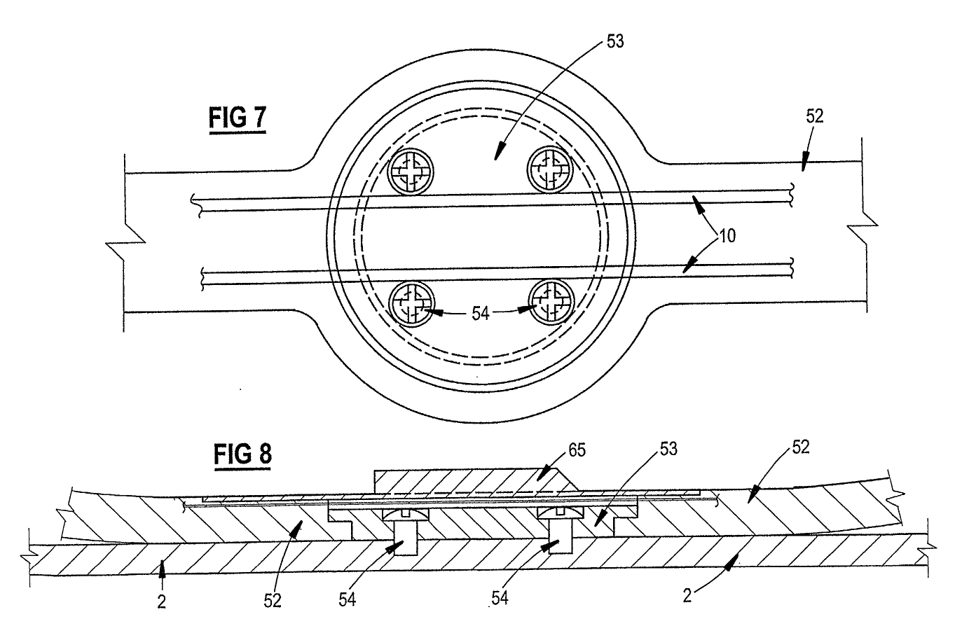

A more detailed view of the front binding 50 without the binding plate attached is shown in FIG. 3. The binding 50 includes a base plate 52 which is generally cross-shaped and has a substantially flat profile with a raised central locating cylinder formation 65. A mounting plate 53 located in the centre of the base plate 52 beneath the locating cylinder 65, allows mounting bolts or screws 54 to extend therethrough and into the snowboard 2. The screws or bolts 54 which pass through the mounting plate 53 and into the upper surface of the snowboard secure the binding 50 against the snowboard upper surface when the screws 54 are tightened so that the heads or flanges thereof bear against the mounting plate 53 which clamps the base plate 52 against the snowboard surface. The mounting plate has a circular construction with peripheral teeth formations which interfit which complementary teeth on the base plate. If the screws 54 are loosened, then the teeth on the mounting plate can be disengaged from the base plate to allow the rotational orientation of the binding 52 to be adjusted with respect to the snowboard 2. The centre portion of one binding is shown in plan and cross-sectional views in FIGS. 7 and 8, respectively. As can be seen in these drawings, the coupling cables 10 may pass over the mounting plate 53 and beneath a cover plate from which the locating cylinder formation 65 projects in the centre of the binding. FIG. 8 also illustrates the manner in which arm portions of the base plate 52 which support the release mechanisms are raised slightly away from the surface of the snowboard, so that the binding does not interfere with the flex of the snowboard any more than a conventional snowboard binding.

Referring again to FIG. 3, two brake mechanisms 60, provided at the front binding only, are disposed toward the respective edges of the snowboard to from the centre of the binding plate. The brake mechanisms are also secured by the mounting plate, but are not rotatably adjustable with the remainder of the base plate. The screws 54 pass through elongate slots in extensions 61 of the brake mechanisms 60 which extend beneath the centre of the base plate 52. Thus, when the screws are tight the mounting plate clamps both the base plate and brake mechanisms in position, but when the screws are loosened the lateral position of the brake mechanisms are adjustable to accommodate different width snowboards. In use, the extensions 61 are adjusted so that each brake mechanism is positioned adjacent its respective edge of a snowboard.

Each brake mechanism 60 comprises a foot pad 63 upon which the bottom of the binding plate or rider's boot is positioned when mounted in the binding. A braking arm 62 extends from the foot pad adjacent the snowboard edge, and is capable of pivotable movement of the free end thereof across the upper surface of the snowboard 2 and downwardly over the edge to which it is adjacent to in use engage the snow and slow or prevent the snowboard from sliding.

Although the braking arm 62 is shown in FIG. 3 in its retracted position, which is the position of the brake during use of the snowboard binding with the rider's foot positioned in the binding, the brake mechanism is in fact spring biased to an extended position. The extended position of the braking mechanism is the braking position (not shown) in which the brake arm 62 extends from the edge of the snowboard to stick into the snow underneath the snowboard to slow or prevent the snowboard from sliding over the snow surface. The braking arm 62 is coupled within the foot pad 63 to a sensor pad structure 64 which is spring biased to project above the surface of the foot pad 63 when the braking arm is in the extended position. The brake mechanism operates as follows. When the boot or binding plate is not mounted in the binding, the braking arm 62 is in the extended position and the sensor pad structure 64 projects from the foot pad by virtue of the spring bias. When the binding is in use, the boot or binding plate forces the sensor pad structure 64 downward against the spring bias where it is held in place by the boot. This action causes the braking arm to retract through the mechanical coupling which pivots the end of the braking arm upwards, and draws the braking arm over the edge of the snowboard. This movement is accomplished through a camming action by intermitting portions of the sensor pad structure and braking arm within the foot pad 63. Thus, the ski brake mechanism 60 extends into its braking position when the rider's foot is removed from the binding 50, and is a safety feature which prevents the snowboard from sliding over the snow without a rider.

Given the possible variations in mounting orientations of the binding 50 with respect to the snowboard 2, features of the binding discussed in detail hereinbelow are described with a frame of reference of the orientation of the intended position of the user's foot when secured in relation to the binding. Thus, reference may be made to the toe and heel sections of the binding, or to the left and right portions thereof, and the left and right portions of each binding will not necessarily correspond to the left and right sides of the snowboard 2 referred to above when the binding is affixed thereto.

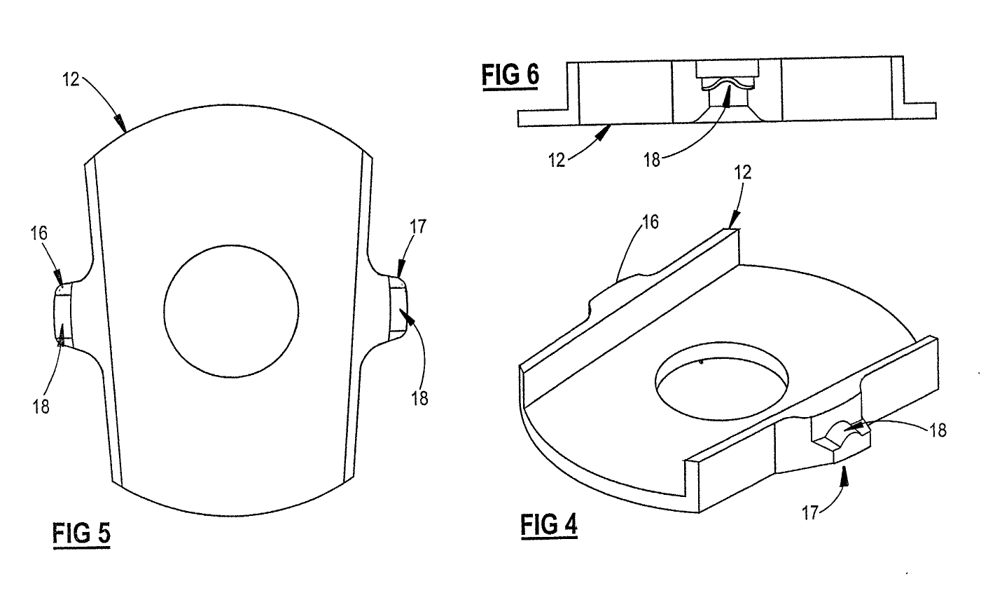

The binding plate 12 is shown in greater detail in FIGS. 4, 5 and 6, and comprises a generally rectangular plate having opposing side location protrusions 16, 17, and a central circular hole to interfit with the locating cylinder 65. The binding plate may be fastened to the bottom of a conventional snowboard boot using a plurality of straps or other secure fastening devices. Alternatively, the binding plate may be integrated into the bottom of a purpose built snowboard boot. The protrusions 16, 17 are located centrally on the sides of the binding plate and are constructed with cam surfaces 18 to interfit wish the snowboard binding as described in greater detail hereinbelow. The cam surface on each protrusion is formed with a generally triangular profile, so that the upper surface of the protrusion is raised in the centre and slopes downwardly in the front and rear directions of the binding plate, and also slopes slightly downwardly in the direction extending away from the binding plate.

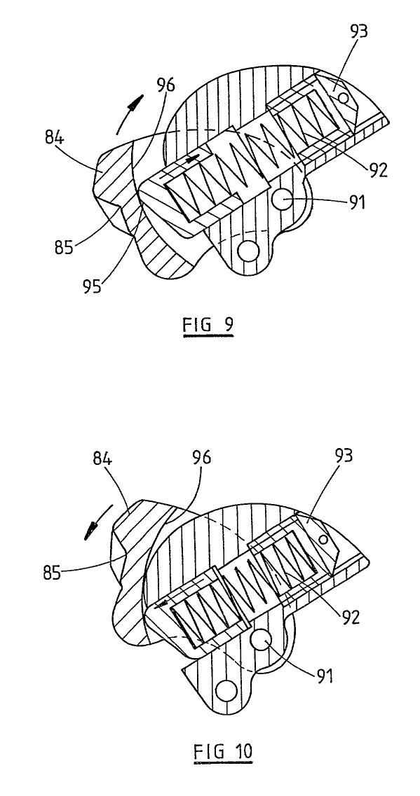

On the left and right “arms” of the cross-shaped base plate 52 shown in FIG. 3, there are mounted respective release mechanisms 80 and 82. The left and right release mechanisms 80, 82 are substantially the same in construction for the purposes of a forced release from the binding, although differences exist for the purposes of a manual release as will be described in detail below. The release mechanisms are mounted on the respective left and right arms of the base plate 52 and have respective release blocks 84 which face inwardly toward the centre of the binding base plate 52. A release mechanism is also shown in partial cross-section in FIGS. 9 and 10 to facilitate explanation of the forced release function of the binding.

The release block 84 has an overhanging extension which protrudes toward the centre of the base plate. On the underneath of the overhanging extension there is formed a recessed cam surface 85 which is complementary in shape to that formed on the protrusions of the binding plate. When the binding plate is mounted in the binding the respective protrusions 16, 17 of the binding plate interfit with the recesses in the left and right release blocks, and the binding plate is thereby held in place in the binding against the base plate 52.

Referring particularly to FIGS. 9 and 10, the release block 84 is mounted to allow pivotal movement thereof about a pivot axis 91. With the binding plate secured in the binding the release block 84 is in the lower pivotal position as shown in FIG. 9. The release block 84 is then able to pivot upwardly as shown in FIG. 10 which allows the respective protrusion of the binding plate to escape from the recess 85 of the release block. The release block is biased toward the lower position by the use of a compression spring 92 which provides a force between the end stop 93 of the release mechanism and a slidably moveable cam member 94. The end 95 of the cam member 94 bears against an internal surface 96 of the release block 84 by action of the compression spring 92. The internal surface 96 of the release block is of substantially constant curvature about an axis which is positioned above the pivot axis 91 of the release block. This structure enables the force of the compression spring 92 to be transmitted to the release block 84 as the release block pivots upwardly. Thus, as the release block pivots up the cam member is forced against the action of the spring 92, which causes the release block 84 to be biased toward the pivotally downward position (FIG. 9). The force provided by the compression spring can be adjusted using the end stop 93 which is rotatable on a screw thread to allow adjustment toward or away from the release block, therefore compressing or releasing the force on the spring to a limited extent.

In order to enable safe release of the rider from the snowboard binding when excessive lifting and/or twisting forces are applied, the release mechanisms are constructed to enable release of the binding plate from the binding when either rotational and/or lifting forces on the binding plate with respect to the board and binding exceed respective thresholds. These thresholds are determined by the compression spring force which is adjustable using the end stop 93 described above, and may be indicated on a release force indicator (not shown in the drawings). For example, if a rotational force is applied to the binding plate with respect to the snowboard, the sloping cam surfaces of the binding plate protrusion 16, 17 bear against the complementary cam surfaces 85 of the release block 84, and when the force is great enough to overcome the compression spring 92 the release block pivots upwardly against the spring bias. The rotational force on the binding plate then causes the binding plate protrusions to clear the release blocks so as to be released from the binding. Similarly, a sufficient upward. force applied by the binding; plate protrusion 16, 17 on the underneath cam surface of the release block also causes the block 84 to pivot upwardly to allow the protrusion to clear the release block overhang and release the binding plate from the binding.

As described above, the same spring 92 controls the force required for forced release from the binding in both lift-out and rotational separations. The rotational and lift-out forces required for release are therefore proportional to one another, and the actual ratio of release forces is dependant upon the slope of the complementary cam surfaces 18 and 85 on the protrusions and release blocks. A shallower slope of the cam surfaces reduces the rotational release force as compared to the lift-out force, and a steeper cam surface slope relatively increases the rotational release force.

As mentioned, for the purposes of the forced release function of the bindings the left and right release mechanisms operate in the same way. However, in order to enable manual release of the binding and an automatic dual release function of the front and rear bindings, one of each of the release mechanisms of the front and rear bindings are constructed with additional features as described below.

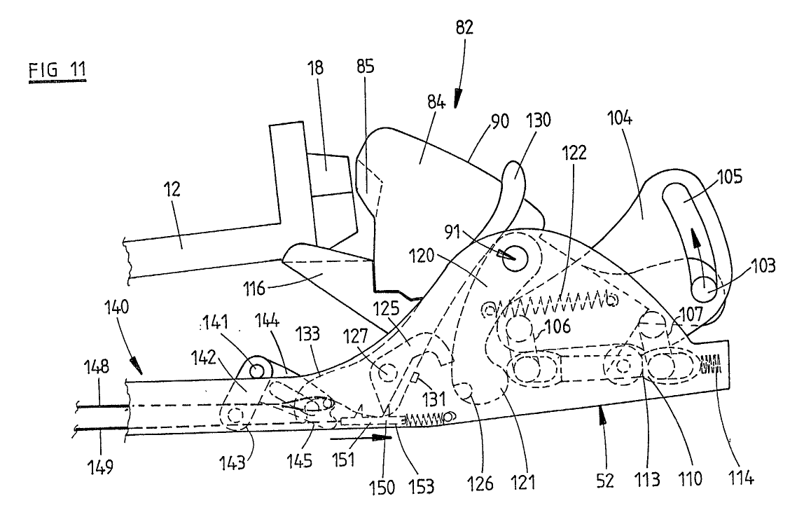

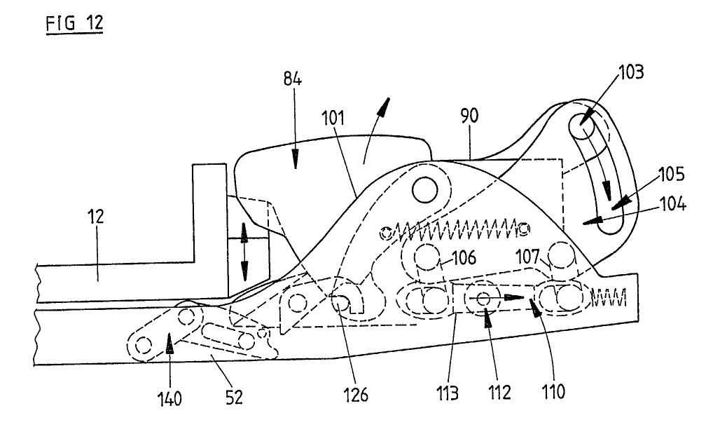

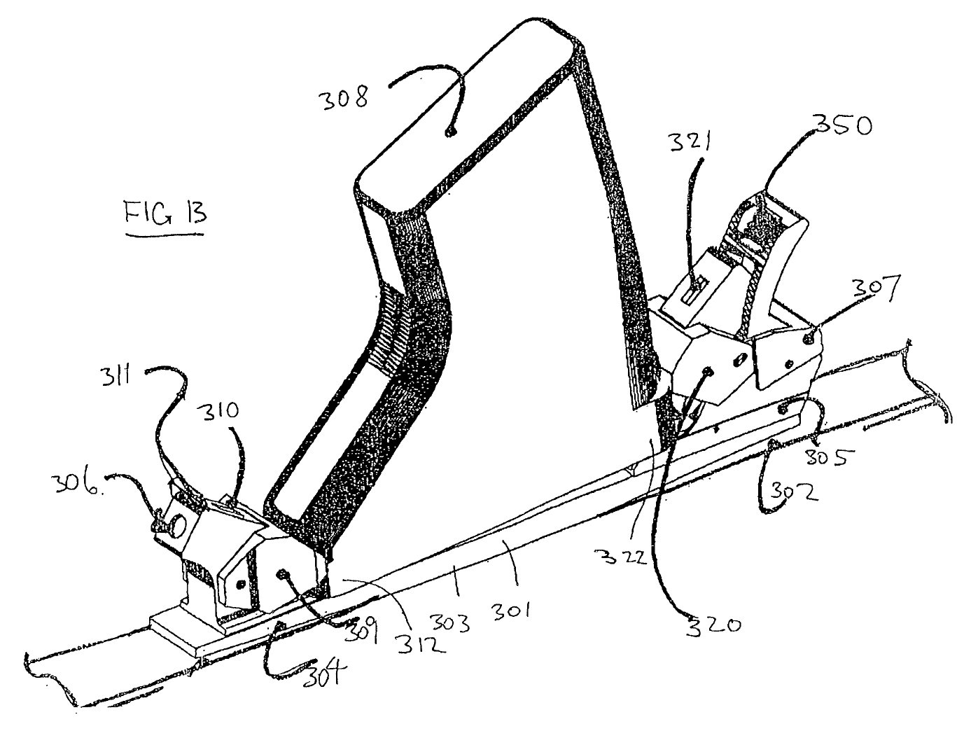

FIGS. 11 and 12 are side views of the right release mechanism of the rear binding, showing internal workings thereof. The corresponding release mechanism on the front binding is constructed substantially the same, with some minor differences which will be explained below. The release mechanism 82 is mounted to the base plate 52 of the binding, and has a release mechanism as described hereinabove including a release block 84 which is pivotal about pivot axis 91. The release block 84 forms part of a latch 90 for securing the binding plate to the binding. The latch 90 is itself also pivotal about the axis 91 between upper and lower pivotal positions shown in FIGS. 11 and 12 respectively. The pivot axis 91 is provided by an axle pin which pivotally couples the latch 90 to a pair of upward extensions 101 of the base plate 52 which extend adjacent the sides of the release mechanism. The rear of the latch is provided with a lug 103 extending transversely therefrom. To the rear of the pivot axis 91 there is also provided a release guide plate 104 having an arcuate slot 105 formed therein within which the lug 103 is moveable. The release guide plate 104 has pivotal connections to the ends of two longitudinally spaced arms 106, 107. The other ends of the arms 106, 107 are coupled at respective ends of a longitudinally moveable carriage 110 positioned between the bottom of the guide plate 104 and the end of the base plate 52. The ends of the arms 106, 107 which are connected to the carriage 110 are pivotally coupled in slightly elongate slots formed in the carriage side, and between the slots the carriage supports a transversely arranged rod or roller 112. The carriage is longitudinally moveable to carry the rod or roller 112 to move within a space 113 which is formed between the bottom edge of the guide plate 104 and a top surface of the base plate 52. The aforementioned components are constructed so that the space 113 is tapered slightly in the longitudinal direction toward the axis 91. The dimension of the slot is dependant upon the positioning of the guide plate 104, which positioning is constrained by the arms 106, 107 and affected by forces acting upon the rear edge of the arcuate slot 105 by the lug 103. The carriage 110 is also spring biased by compression spring 114 so as to urge the rod or roller 112 under the guide plate in the longitudinal direction toward the pivot axis 91. Furthermore the whole latch 90 is itself spring biased about pivot axis 91 (not shown) toward the upward pivotal position shown in FIG. 11. The upward pivotal position of the release mechanism (FIG. 11) is the open position which allows the binding plate 12 to be removed from the binding, and in use the latch is held down in the downward pivotal engaged position (FIG. 12) by action of the guide plate and carriage/roller as will be described below.

As mentioned, the release mechanism is spring biased toward the open position (FIG. 11), which is the configuration allowing the user to mount the binding plate and boot to the binding. In use the binding plate is positioned with one of the protrusions in the recess of the release block (e.g. 88 in FIG. 3) of the release mechanism opposite the mechanism 82. That positions the other binding plate protrusion adjacent the cam recess 85 (FIG. 11) with the edge of the binding plate on a ledge 116 which extends from the release mechanism beneath the cam surface of the release block. By pressing down on the binding plate, the binding plate bears down on the pivotal latch 90 which causes the latch to pivot about the pivot axis 91 such that the lug 103 bears on the edge of the arcuate slot 105 in the guide plate 104. The force of the lug on the slot edge causes movement of the guide plate under the constraint of the arms 106, 107 which slightly widens the space 113. Because the carriage carrying the rod or roller 112 is urged by the spring 114, the rod/roller 112 moves under the guide plate lower edge until it is wedged therein between the bottom of the guide plate and the base plate. The roller 112 therefore acts as a locking mechanism and the guide plate serves as an associated locking element to continuously or incrementally engage the guide plate, as the latch is pivoted toward the engaged position. The mechanical couplings between the guide plate and carriage, the wedging of the rod/roller in the under the guide plate, and the force of the edge of the arcuate slot 105 on the lug 103 therefore locks the release mechanism in position against the spring bias thereon. Return of the latch to the position shown in FIG. 11 is inhibited, since the lug 103 is confined to the upper portion of the slot 105. Movement of the lug 103 along the path of the slot will only be possible if the guide plate 104 is moved to the left, as viewed, however, no such movement is possible since the carriage 10 is wedged in beneath the plate 104. Thus, as the latch 90 moves pivotally downward toward the position illustrated in FIG. 12 it is continually prevented from pivoting back up with the spring bias by the wedging action of the rod/roller in the tapered space 113. This is an advantageous arrangement because it allows the binding plate to be secured in the binding, with the protrusion thereof held in the release block recess, even if the bottom of the binding plate is not completely flat against the base plate which can occur if built up snow or other material is present between the binding plate and base plate.

The mechanism 82 also includes a hammer member 120 which pivots about the axis 91 and has a hammer end 121 aligned with the end of the carriage 110. Intermediate the pivotal mounting and hammer end 121 the hammer 120 is coupled by a tension spring 122 to the release mechanism. The tension spring 122 provides a biasing force on the hammer so that, with the latch in the released position (FIG. 11) the hammer end 121 bears against the carriage 11.0 to force the carriage and rod/roller against the compression spring 114 so that the rod/roller is not wedged in the under the guide plate. As the latch is pivoted down a cam member on the guide plate acts on the hammer so as to withdraw the hammer end against the force of the tension spring 122 to place the hammer in a retracted position illustrated in FIG. 12. The hammer is held in the retracted position by a hooked latch member 125 which hooks over a lug 126 formed adjacent, the hammer end 121. The hammer in the retracted position places the tension spring 122 in an extended, loaded configuration. With the hammer in the retracted position, the release mechanism is in the binding position (FIG. 12) and the carriage 110 positioned so that the rod/roller is wedged in the space 113, preventing upward pivotal movement of the latch. It should be noted that, even though the latch 90 as a whole is prevented from upward pivotal movement about pivot axis 91, the release block 84 is nevertheless able to pivot up to effect a forced release of the binding plate, as described in connection with FIGS. 9 and 10. When the hammer is released from the retracted position by releasing the latch member 125, as described below, the hammer pivots about axis 91 under action of the loaded tension spring 122 such that the hammer end strikes the end of the carriage to drive and hold the rod/roller out of the wedged engagement under the guide plate and allow the upward pivotal movement of the release mechanism.

The latch member 125 controls both the manual release function of the binding and the automatic dual release function, as described below. Manual release is effected by a manual release lever 130 which pivots on the same axis 127 as the latch member. The manual release lever 130 is shown in FIG. 11. A free end of the manual release lever extends from the binding mechanism so as to be actuable by the user by levering it toward the binding centre, the manual release, lever is provided with a lug 131 which bears against the edge of the latch member adjacent where the latch member hooks over the lug 126 of the hammer. Thus, the levering action of the manual release lever by the user causes the lug 131 to draw the hooked latch member 125 away from the hammer lug 126, which releases the hammer to thereby release the binding as described above.

The automatic dual release function of the binding utilises some additional mechanisms including the cable couplings between the front and rear binding mechanisms which are mentioned above. Adjacent the pivot axis 127 of the latch member and manual release lever, a release mechanism is provided which includes a hinged sensor element 140, supported by the base plate 52. The sensor element 140 has first and second portions 142, 144 which are hinged together at mutually coupled edges 141. The other edge 143 of the first portion 141 is pivotally mounted to the base plate, whilst the remaining edge 145 of the second portion is longitudinally slidable within the base plate toward the first portion edge 143, and is also able to pivot. With the second portion edge 145 of the sensor element disposed to its fall extent toward edge 143, the hinged centre 141 of the sensor element 140 projects above the surface of the base plate 52 such as is shown in FIG. 11. The sensor plate can of course only project above the base plate surface if the binding plate is not mounted in the binding. Thus, the longitudinal position to which the edge 145 can slide is determined by whether or not a binding plate is mounted in binding to prevent the sensor element from moving.

The slidable edge 145 of the sensor element is coupled to a coupling cable 148 illustrated in FIG. 11. Considering the rear binding 100 which is shown in part in FIG. 11, the coupling cable 148 extends to the corresponding release mechanism of the front binding, and from the front binding the corresponding coupling cable 149 extends to the binding 100 which is show. It will be recognised that the respective ends of the coupling cables 148, 149 which are not shown in the Figures, with an exception which is noted below, are constructed and operate in the same manner as the complementary ends of the cables which are shown. The end of the coupling cable 149 is connected to a dual release device 150 which is itself connected to a tension spring 152 (see FIG. 11). The dual release device 150 has a ramp shaped catch 151 formed thereon. Depending upon the tension placed on the coupling cable 149 relative to the strength of the tension spring 152, the catch 151 formed on the dual release device 150 is able to move past a lower edge 153 formed on the latch member 125. For example, with a binding plate mounted in the front binding, the sensor element there at is held down, which tensions the coupling cable 149 against the bias of the tension spring to thereby place the catch 151 in a position relative to the latch member lower edge 153 as shown in FIG. 11. Then, if a binding plate were also mounted in the rear binding, the rear binding would be in the condition illustrated in FIG. 12. Consider then if the front binding were to undergo a forced release, through a fall of the rider for example. In that instance the binding plate would be released from the front binding through action of one or both of the release blocks on the front binding, and the tension provided by the spring 152 would draw on the coupling cable 149. Because the sensor element at the front binding is no longer held down by the binding plate, the slidable edge of the sensor element to which the end of cable 149 is connected would slide and raise the sensor element. This would result in movement of the dual release device 150 in the direction to the right as viewed in FIGS. 11 and 12, and cause the catch 151 to bear against the latch member lower edge 153. This causes anticlockwise rotational movement of the latch member, to thereby release the hammer lug and cause release of the latch, as described above. It will be readily understood that a similar sequence of actions would occur at the front binding if the rear binding were to undergo a forced release. Thus, the dual automatic release operates to release both feet if either undergoes a forced release, as is desirable for safe operation of the binding in the event of a fall or accident (luring use, for example.

The difference between the release mechanisms at the front and rear bindings relates to the manual release lever. The manual release lever at the rear binding is provided with a hooked extension 133 (FIG. 11) which engages either the end of the coupling cable 148 or the slidable edge of the sensor element 140 when the manual release lever 130 is actuated by the user. By engaging the coupling cable 148 or sensor element 140 upon actuation of the manual release at the rear binding, the coupling cable is prevented from moving when the rear binding plate is voluntarily removed from the rear binding, and so the front binding does not automatically release as in the case of a forced release condition. This enables the user to remove the rear foot from the snowboard to negotiate ski lifts and the like whilst the front foot remains secured to the front binding. Of course in this situation the front binding plate can still undergo a forced release, or can be manually released using the respective manual release lever. Also, when the rear binding plate is returned into engagement with the rear binding, the bindings are again in a condition for automatic dual release in the event of a forced release of either binding. Furthermore, because the front binding manual release lever does not have the hooked extension 133, if the front binding is manually released and the front binding plate disengaged then the rear binding will also release automatically.

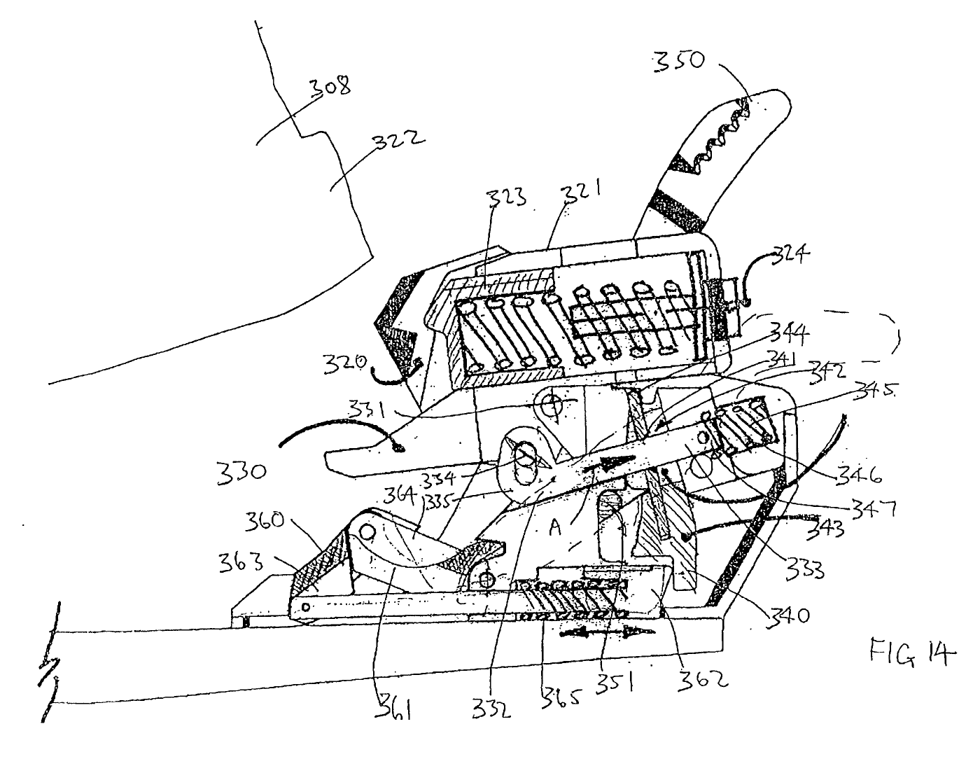

A modified form of release mechanism is shown in FIGS. 13 to 15, which illustrate a binding 301 for a ski 302.

The binding 301 includes a mounting plate 303 which is elevated above the ski 302 at opposed ends 304, 305 thereof to minimise contact between the binding and the ski to increase flexure of the ski and handling performance. A toe and heel assembly 306, 307 are attached to the plate for securing a ski boot 308 therebetween.

The toe assembly 306 comprises a spring-loaded release block 309 which is arranged for limited movement relative to a housing 310 of the toe assembly, preferably in three dimensions, to allow for release of the ski boot where above threshold forces between the boot and ski arise, such as during an accident. The toe assembly may also be provided with a lug 311 which projects upwardly therefrom to use as a scraper to remove material from the sole of the boot prior to stepping into the binding.

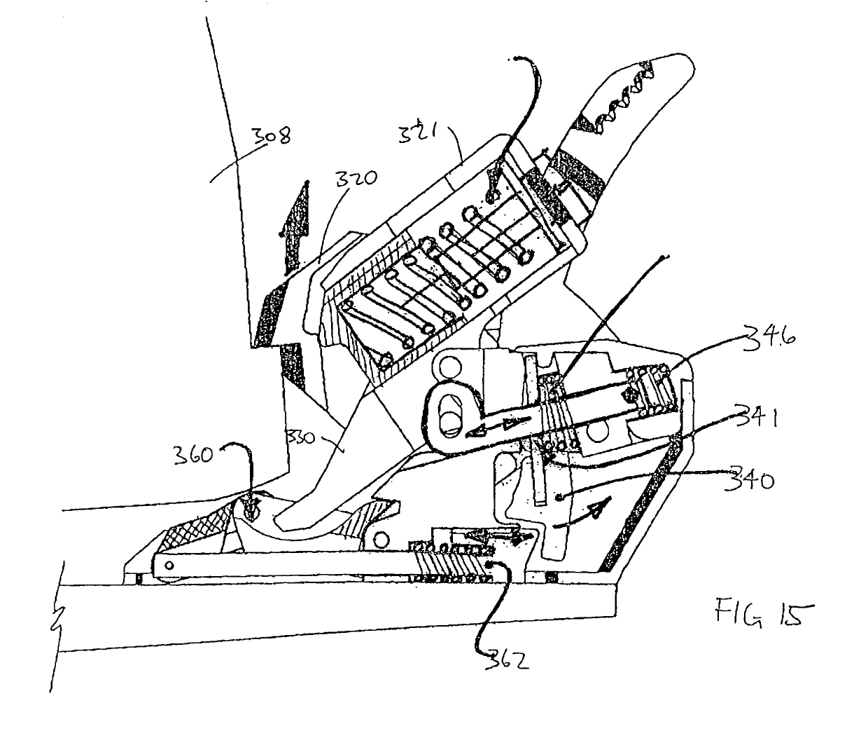

Similar to the toe assembly 306, the heel assembly 307 also includes a release block 320 mounted to a housing 321 to allow for the heel portion 322 of the boot 308 to be released from the binding 301 in overthreshold load conditions. As shown in more detail in FIG. 14, the block 320 is also biased relative to the housing 321, by a spring-loaded ram 323 which has an adjustment dial 324 for changing the level of force required to displace the release block 320 relative to the housing 321. The housing 321 forms part of a latch 330 which, in FIG. 14, is in an open position awaiting receipt of the heel portion 322 of the ski boot 308.

The latch 330 itself is pivotally mounted in the heel assembly 307 for rotation about a main axis 331. A locking element 332, in the form of an elongate bar 333, is coupled to the latch via a pin 334 and follower 335 arrangement. The locking bar is arranged to pass through a lock mechanism 340 which includes a lock gate 341 formed by an aperture 342 in a locking plate 343 which is mounted for pivotal movement about one end 344 thereof. As the latch 330 rotates in an anti-clockwise direction, as viewed, the element 332 travels through the locking plate 343 in a direction indicated by arrow A, so as to provide continuous or incremental locking of the latch. Return movement of the locking element 332 is prevented by frictional engagement between the locking plate 343 and the element 332 so that rotation of the latch toward the open position is inhibited. The locking plate 343 is displaceable relative to the element 332 by pivoting about the end 344 in an anti-clockwise direction, as viewed, to release the friction engagement with the element 332 and allow free movement of the latch 330 back to the open position. A bias means 345 is provided in the form of a spring 346 attached to the remote end 347 of the element 332 so as to bias the latch toward the open position when the lock mechanism is disengaged.

The lock mechanism 340 may therefore be disengaged by being only minimally displaced relative to the element 332, so that only a minimum of force is required to release the latch from the engaged position. The release of the lock mechanism 340 may be effected by way of a manual release handle 350 which may be rotated downwardly and clockwise, as viewed, so that a projection 351 engages the lock plate 343 and pivots it to the disengaged position. Alternatively, an automatic release mechanism 360 is provided in the form of a release device 361 which is displaceable in response to the boot 308 being removed from the binding which in turn drives a hammer 362 against the locking plate 343. The device preferably includes articulated parts 363, 364 coupled together to form an A-frame structure which is substantially flattened when the boot is secured within the binding, at which time, the hammer 362 is retracted away from the locking mechanism 340. A spring 365 may be provided to bias the hammer 362 toward the lock mechanism 340 and raise the articulated arms into the position shown when the ski boot is removed from the binding.

In order to engage the boot 308 in the binding 301, a toe portion 312 of the boot is firstly positioned in the toe assembly 306 and the heel portion 322 of the boot 308 is then lowered into the heel assembly 307 so that the boot 308 flattens the device 361 of the automatic release mechanism 360 and retracts the hammer 362 whilst the latch 330 is simultaneously rotated in an anti-clockwise direction to engage the heel portion 322 and the locking element 332 is driven through the lock mechanism 340 to secure the latch 330 from rotation back toward the open position. FIG. 15 shows the binding with the latch in the engaged position.

If the above threshold forces are applied between the ski boot 308 and the ski 302 the heel portion 322 may force the release block 320 of the heel assembly 307 back toward the housing 321, which results in the boot moving out of the binding and that in turn triggers the automatic release mechanism 360 to fire the hammer 362 against the lock plate 343 and to thereby allow free rotation of the latch 330 to the open position in order to reset the binding 301 for subsequent return of the boot 308 into the binding 301. Alternatively, the boot 308 may firstly release from the toe assembly, in which case however, the latch 330 may still be automatically reset to an open position by virtue of the automatic release mechanism 360 again disengaging the locking mechanism 340. As a further alternative, the manual release lever 350 may be actuated to effect disengagement of the locking mechanism 340.

As may be appreciated from the above, the above described bindings 50 and 301 have lock mechanisms which allow for ease of entry of a boot into the binding and minimal force to manually release the boot. To release the boot, in particular, the force required to release the lock element from the lock mechanism can be set at a relatively low predetermined magnitude, determined only by the interrelationship of the element and mechanism, independent of the entry force required to pivot the latch into the engaged position. Also, the binding may be automatically reset to an open position which significantly increases the ease and convenience of using the binding, as compared to conventional over-centre locking mechanisms which require substantial force to be applied to either release or reset the binding. The binding, accordingly, has particular application to snow skis where application of substantial force to a ski to secure a boot in a binding is perhaps in some circumstances difficult to apply. However, it should be appreciated that the binding may also have application to, for example, snowboards or skis other than snow skis.

The invention has been described by way of non-limiting example only and many modifications and variations may be made thereto without departing from the spirit and scope of the invention described. For example, the structure of the lock element and lock mechanism may be reversed such that the lock element is in the form of a gate and the lock mechanism is instead arranged to pass through the gate for locking engagement therewith, as the latch is pivoted.

1. A binding for releasably holding a boot, including:
a latch arranged to pivot between an open position and an engaged position for securing the boot relative to the binding;
a lock mechanism to provide incremental locking of the latch, as the latch pivots toward the engaged position, in order to restrict movement of the latch back toward the open position.

2. A binding as claimed in claim 1, further including an automatic release mechanism, responsive to the absence of the boot from the binding, to disengage the lock mechanism to allow the latch to be reset to an open position for receipt of the boot.

3. A binding as claimed in claim 2, further including a manual-release for disengaging the lock mechanism independently of the automatic release mechanism.

4. A binding for releasably holding a boot, including:
a latch arranged to pivot between an open position and an engaged position for securing the boot relative to the binding;
a lock element coupled to the latch; and
a lock mechanism for engaging the element to restrict rotation of the latch to the open position, wherein the lock mechanism is arranged to be minimally displaced relative to the lock element to disengage the element and allow rotation of the latch to the open position.

5. A binding for releasably holding a boot, including;
a latch arranged to pivot between an open and an engaged position for securing the boot relative to the binding;
a lock mechanism for restricting rotation of the latch to the open position; and
a release mechanism, responsive to the absence of the boot from the binding, to disengage the lock mechanism to allow the latch to be reset to an open position for receipt of the boot.

6. A binding for releasably holding a boot, including:
a latch arranged to pivot between an open and an engaged position for securing the boot relative to the binding;
a lock mechanism for restricting rotation of the latch to the open position; and
an automatic release mechanism, responsive to the absence of the boot from the binding, to disengage the lock mechanism to allow the latch to be reset to an open position for receipt of the boot.

7. A binding as claimed in claim 6, further including a manual-release for disengaging the lock mechanism independently of the automatic release mechanism.
